(19) United States
(12) Patent Application Publication
(10) Pub. No.: US 2019/0077180 A1
(43) Pub. Date: Mar. 14, 2019

(54) APPARATUS FOR TURNING PAGES OF BOOK AND METHOD FOR SUPPORTING BOOK

(71) Applicant: CASIO COMPUTER CO., LTD., Tokyo (JP)

(72) Inventors: Hirokazu HASEGAWA, Tokyo (JP); Toshiaki KANAMURA, Tokyo (JP); Yasushi MURAI, Tokyo (JP)

(73) Assignee: CASIO COMPUTER CO., LTD., Tokyo (JP)

(21) Appl. No.: 16/026,969

(22) Filed: Jul. 3, 2018

(30) Foreign Application Priority Data
Sep. 13, 2017 (JP) 2017-175914

(51) Int. Cl. B42D 9/04

(52) U.S. Cl. CPC B42D 9/04; H04N 1/0066

(57) ABSTRACT

Support auxiliary members are each constituted by an elongate member having a triangular prism shape and extending from one end to the other end of a holding plate. The support auxiliary member is arranged between a book holder and the final page of a book at a page-turning start point, and supports the vicinity of a binding portion of the book so as to lift it from below. The support auxiliary member is arranged between the holding plate and a spine portion of the book placed on the holding plate, and supports the spine portion. The support auxiliary members form a V-shaped structure only in the vicinity of the binding portion of the book because of their shapes and installation positions, whereby the spine portion of the book is held in a downwardly curved state.

### CROSS-REFERENCE TO RELATED APPLICATION

This application is based upon and claims the benefit of priority from the prior Japanese Patent Application No. 2017-175914, filed Sep. 13, 2017, the entire contents of which are incorporated herein by reference.

### BACKGROUND OF THE INVENTION

### 1. Field of the Invention

The present invention relates to an apparatus for turning pages of a book and a method for supporting the book.

### 2. Description of the Related Art

Conventionally, an apparatus is known which turns overlapping pages of a book or the like one by one by sticking thereto (refer, for example, to Japanese Patent Application Laid-Open (Kokai) Publication No. 2016-010907). This apparatus repeats operations of holding a book B on a holding table 100 such that it is opened at a predetermined angle, holding and turning a page P of the book B by a sticking section 101 which reciprocates a circular arc trajectory L, and catching and pressing the turned page P by a page holding section 102 constituted by a roller or the like on the page-turning end side so that the page P does not return to the page-turning start point, whereby pages of the book are sequentially turned, as shown in FIG. 4A.

Here, when air W is blown against the back side of the page P being turned by the sticking section 101 from an air blowing section (not shown) arranged above the page-turning start point of the book B, the page P is guided to the page-turning end point after being separated from the sticking section 101, which prevents the page P from returning to the page-turning start point. In the process of the operation for sequentially turning pages P, the pages P are sequentially imaged by a camera connected to a personal computer, a mobile phone with a camera, a smartphone, a tablet, or the like (not shown) so as to achieve the digitalization of the book B.

In the above-described apparatus, when the size of the book B is large or if the stiffness of paper is high due to the paper quality of the page P, even if the air W is blown from the air blowing section as shown in FIG. 4A, the page P cannot be sufficiently turned over by the sticking section 101 (the sticking section 101 separates from the page P while turning the page P), and the air W may not reach the page holding section 102 at the page-turning end point. Note that the stiffness of the paper means the rigidity of the paper, and represents resistance when a bending force is applied to the paper.

In such a case, a semi-automatic mode for pressing and holding the turned page P at the page-turning end point by hand without using the page holding section 102 is used. However, pressing all the pages by hand imposes an excessive burden on the user.

Also, it is known that, when a book B is fixed to a holding table 200 having a V-shaped structure as shown in FIG. 4B, even if the size of the book B is large or the stiffness of the paper is high due to the paper quality of the pages P, the pages P can be easily opened. However, there is a problem in that a page holding section 202 enters the viewing angle of a camera 203 and hides a page to be imaged because the opening angle of the book B is small.

### SUMMARY OF THE INVENTION

In accordance with one aspect of the present invention, there is provided an apparatus for turning pages of an opened book, comprising: a holding table which holds the opened book by a pair of holding plates; a main body section which turns a target page of the opened book to a page-turning end point by a sticking section sticking to the target page at a page-turning start point; and an auxiliary member which supports a spine portion of the book held by the holding table in a downwardly curved state.

In accordance with another aspect of the present invention, there is provided an apparatus for turning pages of an opened book, comprising: a holding table which holds the opened book by a pair of holding plates; a main body section which turns a target page of the opened book by a sticking section sticking to the target page at a page-turning start point; and an auxiliary member which supports a spine portion of the book held by the holding table such that an angle on an acute angle side formed between a normal line of the spine portion of the book and a horizontal plane becomes larger.

In accordance with a third aspect of the present invention, there is provided a method for supporting a book held in an opened state by a holding table including a pair of holding plates, wherein a first auxiliary member arranged between the holding table and a final page at a page-turning start point of the book lifts vicinity of a binding portion of the book from below so as to support a spine portion of the book in a downwardly curved state.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention will be readily understood by the following detailed description in conjunction with the accompanying drawings.

FIG. 1 is a perspective view showing a schematic structure of a page turner 1 according the present embodiment;

FIG. 2A, FIG. 2B and FIG. 2C are each a cross sectional view for describing an effect of a V-shaped structure formed by support auxiliary members 50 and 51 by a page turner 1 according the present embodiment;

FIG. 3A, FIG. 3B and FIG. 3C are each a cross sectional view for describing another V-shaped structure formed by the support auxiliary members 50 and 51 by the page turner 1 according the present embodiment; and

FIG. 4A and FIG. 4B are each a conceptual diagram for describing a page-turning operation that is performed in a conventional page turner.

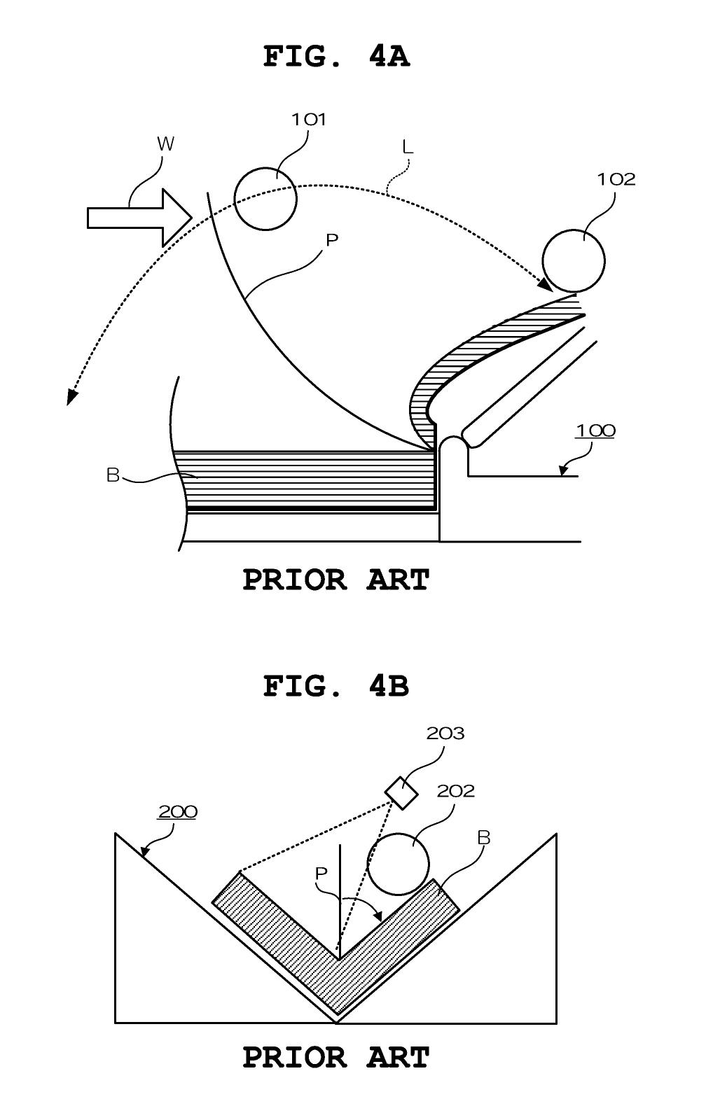

### DETAILED DESCRIPTION OF THE PREFERRED EMBODIMENT

A preferred embodiment of the present invention will hereinafter be described with reference to the accompanying drawings. Note that, although the embodiment described below is provided with various technically preferable limitations in order to carry out the present invention, these limitations are not intended to limit the scope of the present invention to the embodiment and examples shown in the drawings.

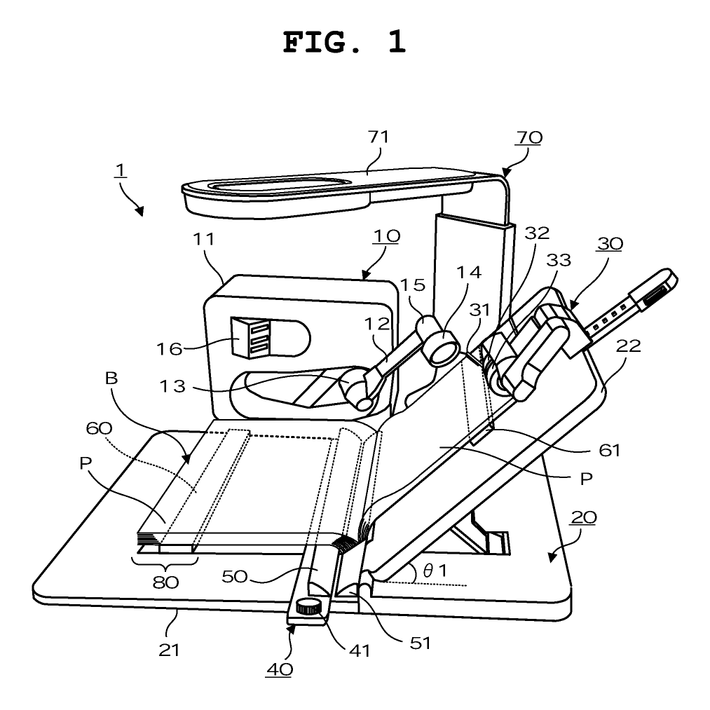

FIG. 1 is a perspective view showing the appearance of a page turner 1 according to an embodiment of the present invention. Note that in the following descriptions a case is described in which pages P of a book B are turned from left to right. In FIG. 1, the page turner 1 includes a page-turning main body section 10 which turns pages P of the book B, a holding table 20 which holds the opened book B, a page holding section 30 which holds pages P at a page-turning end point, a book holder 40 which fixes the book B held by the holding table 20, support auxiliary members 50 and 51, end spacers 60 and 61, and an imaging apparatus stand 70 on which an information processing terminal (a smartphone, a tablet, etc.) including a camera for photographing pages P of the book B is installed.

The page-turning main body section 10 includes an accommodation case 11 having a substantially rectangular parallelepiped shape, an arm section 12 which can be accommodated in the accommodation case 11, a first driving section 13 such as a motor which swings the arm section 12 from right to left and from left to right, a sticking section (sticking roller section) 14 which is attached to a distal end of the arm section 12 and sticks to a page P of the book B, a second driving section 15 such as a motor which rotates the sticking section 14, an air blowing section 16 which makes air pass above pages P at a page-turning start point and blows air against a page P being turned by the sticking section 14 so as to assist the page-turning operation, or separates the page P from the sticking section 14, and a control section not shown which controls respective operations of the sections. A position and a direction of the page-turning main body section 10 with respect to the holding table 20 can be adjusted as needed, based on the size of the book B.

The holding table 20 includes a pair of holding plates 21 and 22 which is foldable by a hinge. Here, in the case where pages P of the book B are turned from left to right, the one holding plate 21 located on the left side in the pair of holding plates 21 and 22 is placed along the top of the table, and the other holding plate 22 located on the right side is placed on the table while being inclined to rise at a predetermined angle to the one holding plate 21. On the one holding plate 21, the book B whose pages P have not been turned is placed. That is, a position on the side of the one holding plate 21 becomes a page-turning start point of each page P. On the other holding plate 22, turned pages P are held. That is, a position on the side of the other holding plate 22 becomes a page-turning end point of each page P.

As a result, the holding table 20 holds the book B such that pages P at page-turning end points are more inclined in a direction to rise with respect to the seam of the book B than pages P at page-turning start points. Note that, since the pair of holding plates 21 and 22 is foldable by the hinge, an angle formed between the pair of holding plates 21 and 22 can be adjusted and a tilt angle θ1 of a page P at a page-turning end point with respect to the horizontal plane is adjustable. The tilt angle θ1 is preferably adjusted in a range of 30° to 45°.

The page holding section 30 includes a catching section 31 which catches a page P turned by the reciprocable swing of the sticking section 14 and thereby prevents the page P from returning to the page-turning start point, a pull-in roller 32 which rotates coaxially with the catching section 31 and pulls in a page P conveyed by the sticking section 14 and caught by the catching section 31 so as to prevent the page P from returning to the page-turning start point, and a pressing roller 33 which presses a page P at a page-turning end point.

The book holder 40, which is constituted by an elongate plate-like member extending from one end to the other end of the holding plate 21, is inserted between the front cover (or back cover) of the book B placed on the holding plate 21 and the final page P, and is fixed to the holding plate 21 by tightening a fixing knob 41 to prevent the book B from shifting during the page-turning operation.

Each of the support auxiliary members 50 and 51 is constituted by an elongate member having a triangular prism shape and extending from the one end to the other end of the holding plate 21. The support auxiliary member 50 is arranged between the book holder 40 and the final page P at the page-turning start point, and supports the vicinity of a binding portion (inner margin) of the book B to lift it at a predetermined angle (e.g., approximately 30°) from below. That is, an inclined surface of the support auxiliary member 50, which comes in contact with the final page P at the page-turning start point, is approximately 30° to the horizontal plane. As a result, a spine portion of the book B is held in a downwardly curved state. Here, each of the support auxiliary members 50 and 51 need not necessarily have a length extending from one end to the other end of the holding plate 21, but may extend along the seam of the book B. That is, each of the support auxiliary members 50 and 51 is only required to have a predetermined length extending from one end to the other end of the holding plate 21.

The support auxiliary member 51 is arranged between the holding plate 21 and the spine portion of the book B placed on the holding plate 21, and supports the spine portion of the book B such that the spine portion of the book B is held at a predetermined angle (e.g., approximately 30°) to the horizontal plane. That is, an inclined surface of the support auxiliary member 51, which comes in contact with the spine portion of the book B, is approximately 30° to the horizontal plane.

Thus, the support auxiliary members 50 and 51 form a V-shaped structure only in the vicinity of the binding portion of the book B due to their respective shapes and installation positions, whereby the spine portion of the book B is held in a downwardly curved state. In other words, the support auxiliary members 50 and 51 are each held such that an angle on the acute angle side formed between a normal line of the spine portion of the book B and the horizontal plane becomes larger. Accordingly, even if the size of the book B is large and the stiffness of the paper of the page P is high, a page P at a page-turning start point can be easily warped toward a page-turning end point by the stiffness of the paper (the page P) of the book B and a force occurred by the spine portion being downwardly curved, and can be more easily turned by a sticking force of the sticking section 14 and a force of air from the air blowing section 16.

Also, the support auxiliary members 50 and 51 form the V-shaped structure only in the vicinity of the binding portion of the book B due to their respective shapes and installation positions, whereby the opening angle of the book B can be made large. Accordingly, the opening angle of the book B can be prevented from decreasing, which prevents the page holding section 30 from entering the viewing angle of the camera in the information processing terminal and hiding a page to be imaged.

Note that the spine portion of the book B is held in a downwardly curved state and therefore printed surfaces of the book B are floated and curved. Therefore, in the present embodiment, the end spacer 60 is inserted between the holding plate 21 and the final page of the book B on an end portion 80 (outer margin) side of the book B. When the end spacer 60 is inserted, a portion other than the binding portion, i.e., the printed surface of a page P at a page-turning start point of the book B is kept in an almost horizontally opened, whereby an image to be captured can be inhibited from being distorted.

The imaging apparatus stand 70 includes a stage 71 extending in a direction diagonal to a page P at a page-turning start point of the opened book B (a page P which has not been turned) serving as an imaging target and parallel to the installation surface of the imaging apparatus stand 70. On the stage 71, a tablet terminal (not shown) is installed as an information processing terminal, and a camera portion of the tablet terminal photographs a page P at a page-turning start point (a page P which has not been turned) of the book B via an opening portion provided in the stage 71. The position and the direction of the imaging apparatus stand 70 can be adjusted as needed based on the size of the book B.

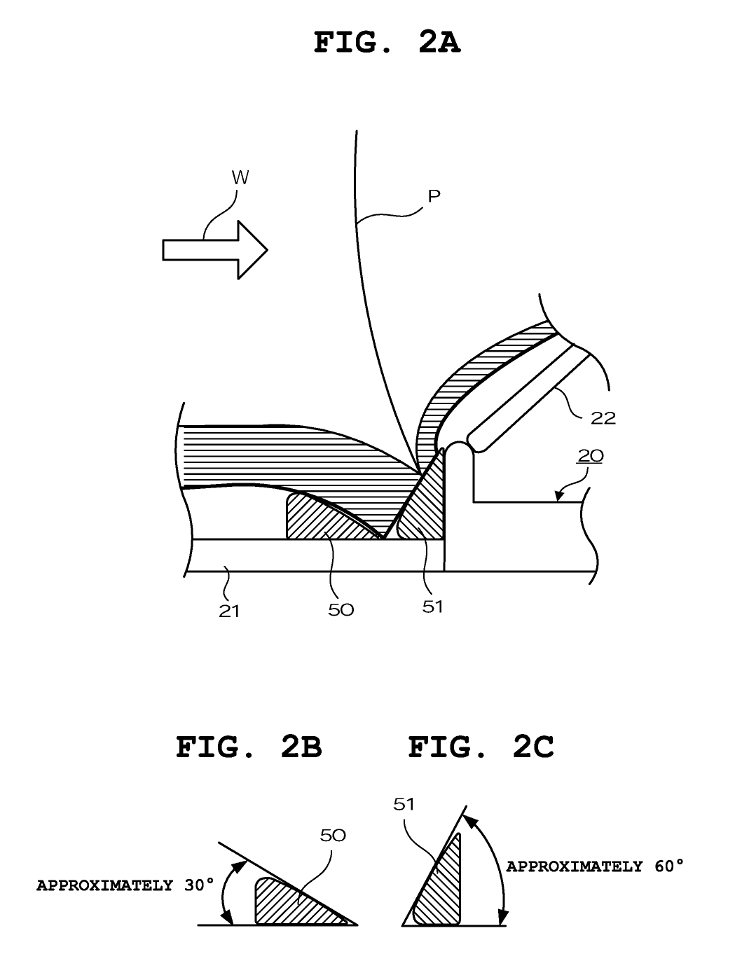

FIG. 2A, FIG. 28, and FIG. 2C are each a cross sectional view for describing an effect of the page turner 1 according the present embodiment by the V-shaped structure formed by the support auxiliary members 50 and 51.

In the present embodiment, the vicinity of the binding portion of the book B is supported to be lifted at a predetermined angle (e.g., approximately 30°) from below, as shown in FIG. 2A and FIG. 2B. The spine portion of the book B is held at a predetermined angle (e.g., approximately 60°) to the horizontal plane, as shown in FIG. 2A and FIG. 2C. Therefore, the spine portion of the book B is supported in a downwardly curved state by the V-shaped structure formed by the support auxiliary members 50 and 51. Accordingly, a page P at a page-turning start point can be easily warped toward a page-turning end point by the stiffness of the paper (the page P) of the book B and a force caused by the spine portion being downwardly curved, and can be more easily turned with the sticking force of the sticking section 14 and the force of air from the air blowing section 16.

In such a structure, it has been confirmed that, even if the size of the book B is large or if the stiffness of the paper is high due to the paper quality of the pages P, each page P can be turned over until it becomes substantially vertical (approximately 90°) only by blowing air W from the air blowing section 16, as shown in FIG. 2A. Therefore, even if the size of the book B is large or if the stiffness of the paper of the pages P is high, each page P can be reliably and easily delivered to the page holding section 102 at a page-turning end point.

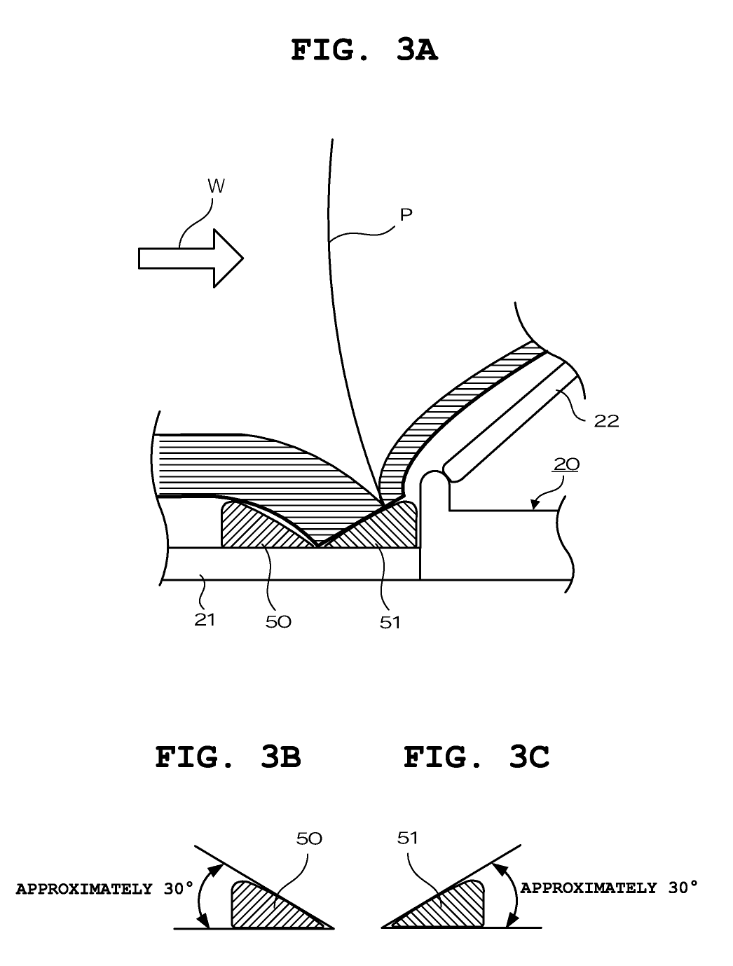

FIG. 3A, FIG. 3B, and FIG. 3C are each a cross sectional view for describing another V-shaped structure formed by the support auxiliary members 50 and 51 by the page turner 1 according the present embodiment.

In an example shown in FIG. 3A and FIG. 3B, a method for installing the support auxiliary member 50 is the same. However, the support auxiliary member 51 supports the spine portion of the book B at approximately 30° to the horizontal plane by changing the direction of the installation, as shown in FIG. 3A and FIG. 3C. Thus, when the spine portion of the book B is supported at approximately 30°, even if a page P of the book B is difficult to turn, i.e., the stiffness of the paper of the page P is higher, a force caused by the spine portion being downwardly curved becomes large. Therefore, the page P easily warps toward its page-turning end point, and is more easily turned by the sticking force of the sticking section 14 and the force of air from the air blowing section 16.

Note that, although a cross-sectional shape of each of the support auxiliary members 50 and 51 is a substantially right triangular shape and an angle formed by hypotenuses is approximately 30° in the present embodiment, the cross-sectional shape and the angle formed by the hypotenuses are not limited thereto and may be changed as needed based on the size of the book B, the stiffness of the paper (the page P) of the book B, or the like. Alternatively, a plurality of support auxiliary members 50 or 51, which are made to differ in a cross-sectional shape, an angle formed by hypotenuses, or the like may be prepared and replaced in accordance with the size of the book B, the stiffness of the paper (the page P) of the book B, and the like.

In the above-described structure, when the first driving section 13 is rotated, the arm section 12 reciprocates between a page-turning start point of pages P and a page-turning end point thereof as if it draws an arc centered on the first driving section 13. In the following descriptions, a movement from a page-turning start point of pages P to a page-turning end point thereof is regarded as a forward movement, and a movement from a page-turning end point to a page-turning start point is regarded as a backward movement.

First, the user rotates the arm section 12 and the sticking section 14 to pull them out of the accommodation case 11 in the page turner 1 in an accommodated state, and switches the page turner 1 to an operation state in which the arm section 12 operates (see FIG. 1). Then, the user installs the holding table 20, installs the support auxiliary member 51 in a joint portion between the holding plate 21 and the holding plate 22, and then places the book B on the holding plate 21 such that the spine portion of the book B comes in contact with the support auxiliary member 51. Then, the user inserts the book holder 40 and the support auxiliary member 50 between the front cover (or the back cover) of the book B placed on the holding plate 21 and the final page P, and fixes the book holder 40 to the holding plate 21 by tightening the fixing knob 41 in the book holder 40. Then, the user inserts the end spacer 60 between the holding plate 21 on the end portion (outer margin) side of the book B and the book B, and inserts the end spacer 61 between the holding plate 22 and the book B.

After placing the book B, the user sets the page holding section 30 on the holding plate 22 while adjusting its position, and manually inserts and fixes the front cover of the book B into and to the page holding section 30. Note that the front cover of the book B may be fixed with a clip not shown. Next, the user adjusts the moving direction of air W from the air blowing section 16 such that the air W passes above pages P at page-turning start points and is blown onto a page P at a page-turning end point.

Also, the user aligns the arm section 12 such that the sticking section 14 is arranged at a start point (an end point of a backward movement) in advance. More specifically, the user also aligns the holding table 20 such that the sticking section 14 comes in contact with the vicinity of the upper left of a page P at a page-turning start point. Then, the user opens the book B to the preceding page P of a page P which the user desires to start to scan, and moves the sticking section 14 to an end point of a forward movement (a start point of a backward movement) in advance. Also, the user adjusts the position of the information processing terminal on the stage 71 in the imaging apparatus stand 70 such that the page P at the page-turning start point comes within the viewing angle of the camera in the information processing terminal (not shown).

When the preparation is completed and therefore the user turns on the page turner 1, the control section not shown executes a program for page-turning processing. First, when the page-turning operation is started, the arm section 12, i.e., the sticking section 14 moves to the page-turning start point by the first driving section 13, and sticks to the first page P. Then, when the arm section 12, i.e., the sticking section 14 rotates toward the page-turning end point by the first driving section 13, an end portion of the page P to which the sticking section 14 has been stuck moves to the page-turning end point by the sticking section 14. During this time period, air W from the air blowing section 16 is constantly blown onto the page P.

The spine portion of the book B is supported to be downwardly curved at a predetermined angle (e.g., approximately 30°) to the horizontal plane by the V-shaped structure formed by the support auxiliary members 50 and 51. Therefore, even if the size of the book B is large or if the stiffness of the paper of the page P is high due to the paper quality of the page P, the page P at the page-turning start point easily reaches the page-turning end point due to the stiffness of the paper (the page P) of the book B and a force occurred by the spine portion being downwardly curved.

Furthermore, when the arm section 12 rotates, the sticking section 14 rotates by the second driving section 15, and the end portion of the page P to which the sticking section 14 has been stuck separates from the sticking section 14. Here, the spine portion of the book B is supported to be downwardly curved at a predetermined angle (e.g., approximately 30°) to the horizontal plane by the V-shaped structure formed by the support auxiliary members 50 and 51, whereby the page P reliably separates from the sticking section 14 due to the stiffness of the paper (the page P) of the book B, the force caused by the spine portion being downwardly curved, and the air W from the air blowing section 16. The page P, which has separated from the sticking section 14, is caught in the page holding section 30, and is held on the holding plate 22.

Then, when the first driving section 13 and the second driving section 15 are stopped by the control section not shown, the arm section 12 attempts to continue to rotate clockwise due to its inertial force. However, a stopper (not shown) provided in the accommodation case 11 restricts further rotation. At this timing, a page-turning completion signal is outputted to the information processing terminal not shown from the control section, and the information processing terminal controls the camera based on the inputted page-turning completion signal so as to photographs a page P at a page-turning start point of the opened book B. Here, since the end spacer 60 has been inserted between the holding plate 21 on the end portion (outer margin) side of the book B and the book B, the pages P at page-turning start points are kept in a substantially horizontal state. Accordingly, the captured image is inhibited from being distorted.

The above-described page-turning operation and imaging operation are performed up to the final page or until the user inputs an end instruction. The data of images captured by the camera are numbered one by one (for each image capturing), and recorded in a recording section (a memory or a recording medium) in the information processing terminal. In this case where only the pages P corresponding to page-turning start points, such as odd-numbered pages, are imaged, images acquired by photographing only the odd-numbered pages and images acquired by photographing only the even-numbered pages by arranging the even-numbered pages at page-turning start points are alternately rearranged in the page order as scan images corresponding to all the pages. Then, when the page-turning operation and the imaging operation are performed up to the final page or when the user inputs an end instruction, the page-turning operation and the imaging operation are ended.

According to the above-described embodiment, when a page P of the opened book B held by the holding table 20 including the pair of holding plates 21 and 22 opened at a predetermined angle is held at a page-turning start point so as to be turned to a page-turning end point, the support auxiliary members 50 and 51 support the spine portion of the book B held by the holding table 20 in a downwardly curved state. Therefore, even if the size of the book B is large or the stiffness of the paper is high due to the paper quality of the page P, the page P at the page-turning start point easily reaches the page-turning end point by the stiffness of the paper (the page P) of the book B and a force occurred by the spine portion being downwardly curved, whereby page-turning is achieved.

Also, according to the above-described embodiment, the support auxiliary member 50 is arranged between the holding table 20 and the final page at a page-turning start point of the book B so as to lift and support the vicinity of the binding portion of the book B from below. Therefore, the spine port ion of the book B held by the holding table 20 can be supported in a downwardly curved state, and pages P of the book B can be easily turned.

Moreover, according to the above-described embodiment, the support auxiliary member 51 is arranged between the holding table 20 and the spine portion of the book B so as to hold the spine portion of the book B at a predetermined angle with respect to the horizontal plane. Therefore, the spine portion of the book B held by the holding table 20 can be supported in a downwardly curved state, and pages P of the book B can be easily turned.

Furthermore, according to the above-described embodiment, the support auxiliary members 50 and 51 form the V-shaped structure only in the vicinity of the binding portion of the book B, whereby the opening angle of the book B can be made large.

Still further, according to the above-described embodiment, the end spacer 60 is inserted between the holding table 21 on the end portion 80 (outer margin) side of the book B and the final page of the book B. Therefore, a portion other than the binding portion of the book B, that is, the printed surfaces of pages P at page-turning start points are kept in a substantially horizontally opened state, whereby images to be captured can be inhibited from being distorted.

While the present invention has been described with reference to the preferred embodiments, it is intended that the invention be not limited by any of the details of the description therein but includes all the embodiments which fall within the scope of the appended claims.

What is claimed is:

1. An apparatus for turning pages of an opened book, comprising:
a holding table which holds the opened book by a pair of holding plates;
a main body section which turns a target page of the opened book to a page-turning end point by a sticking section sticking to the target page at a page-turning start point; and
an auxiliary member which supports a spine portion of the book held by the holding table in a downwardly curved state.

2. The apparatus according to claim 1, wherein the auxiliary member includes a first auxiliary member which is arranged between the holding table and a final page at a page-turning start point of the book, and lifts and supports vicinity of a binding portion of the book from below.

3. The apparatus according to claim 2, wherein the auxiliary member includes a second auxiliary member which is arranged between the holding table and the spine portion of the book and supports the spine portion of the book such that the spine portion of the book is held at a predetermined angle with respect to a horizontal plane.

4. The apparatus according to claim 3, wherein the first auxiliary member and the second auxiliary member form a V-shaped structure where the vicinity of the binding portion of the book is lifted from below and the spine portion of the book held by the holding table is supported in a downwardly curved state.

5. The apparatus according to claim 2, further comprising:
a spacer which is inserted between the holding table and the final page at the page-turning start point, on an outer margin side of the book, and supports the final page at the page-turning start point from below such that an upper surface of the target page at the page-turning start point becomes substantially horizontal.

6. The apparatus according to claim 2, wherein the first auxiliary member is an elongate member which has a triangular prism shape and extends from one end to an other end of the holding plate.

7. The apparatus according to claim 3, wherein the second auxiliary member is an elongate member which has a triangular prism shape and extends from one end to an other end of the holding plate.

8. The apparatus according to claim 7, wherein a cross section perpendicular to a longitudinal direction of the second auxiliary member has a right triangular shape.

9. The apparatus according to claim 7, wherein one of corners of a cross section perpendicular to a longitudinal direction of the second auxiliary member has an angle that is twice as large as an angle of one of other corners.

10. The apparatus according to claim 1, wherein the auxiliary member is an elongate member having a triangular prism shape and extending from one end to an other end of the holding plate, is arranged between the holding table and the spine portion of the book, and supports the spine portion of the book such that the spine portion of the book is held at a predetermined angle with respect to a horizontal plane.

11. The apparatus according to claim 10, wherein a cross section perpendicular to a longitudinal direction of the auxiliary member has a right triangular shape.

12. The apparatus according to claim 10, wherein one of corners of a cross section perpendicular to a longitudinal direction of the auxiliary member has an angle that is twice as large as an angle of one of other corners.

13. An apparatus for turning pages of an opened book, comprising:
a holding table which holds the opened book by a pair of holding plates;
a main body section which turns a target page of the opened book by a sticking section sticking to the target page at a page-turning start point; and
an auxiliary member which supports a spine portion of the book held by the holding table such that an angle on an acute angle side formed between a normal line of the spine portion of the book and a horizontal plane becomes larger.

14. The apparatus according to claim 13, wherein the auxiliary member includes a first auxiliary member which is arranged between the holding table and a final page at a page-turning start point of the book, and lifts and supports vicinity of a binding portion of the book from below.

15. The apparatus according to claim 14, wherein the auxiliary member includes a second auxiliary member which is arranged between the holding table and the spine portion of the book and supports the spine portion of the book such that the spine portion of the book is held at a predetermined angle with respect to a horizontal plane.

16. The apparatus according to claim 13, wherein the auxiliary member is an elongate member having a triangular prism shape and extending from one end to an other end of the holding plate, is arranged between the holding table and the spine portion of the book, and supports the spine portion of the book such that the spine portion of the book is held at a predetermined angle with respect to a horizontal plane.

17. A method for supporting a book held in an opened state by a holding table including a pair of holding plates, wherein a first auxiliary member arranged between the holding table and a final page at a page-turning start point of the book lifts vicinity of a binding portion of the book from below so as to support a spine portion of the book in a downwardly curved state.

18. The method according to claim 17, wherein a second auxiliary member arranged between the holding table and the spine portion of the book held by the holding table supports the spine portion of the book such that the spine portion of the book is held at a predetermined angle with respect to a horizontal plane.

19. The method according to claim 18, wherein one surface of the first auxiliary member which lifts the vicinity of the binding portion of the opened book and one surface of the second auxiliary member which supports the spine portion of the opened book held by the holding table in a downwardly curved state form a V-shaped structure.
